(19) United States
(12) Patent Application Publication
(10) Pub. No.: US 2009/0179726 A1
(43) Pub. Date: Jul. 16, 2009

(54) Inductor that contains magnetic field propagation

(76) Inventors: Carl W. Berlin, West Lafayette, IN (US); David W. Zimmerman, Fishers, IN (US); Aleksandra Djordjevic, Plano, TX (US)

Correspondence Address: DELPHI TECHNOLOGIES, INC., M/C 480-410-202, PO BOX 5052, TROY, MI, 48007, US

(21) Appl. No.: 12/008,371

(22) Filed: Jan. 10, 2008

(51) Int. Cl. H01F 27/34

(52) U.S. Cl. 336/84 R

(57) ABSTRACT

An inductor and method of containing a magnetic field is provided. The inductor includes a first set of layers wound in a first predetermined direction, wherein each layer of the first set of layers is electrically connected to one another, and a second set of layers wound in a second predetermined direction, wherein each layer of the second set of layers is electrically connected to one another and the first set of layers, and the second set of layers is between a top layer and a bottom layer, such that the top layer forms a first pair with a first layer of the second set of layers, and the bottom layer forms a second pair with a second layer of the second set of layers so that the magnetic field is substantially contained, such as to remain substantially within a gap defined between each layer of the pairs of layers.

### TECHNICAL FIELD

The present invention generally relates to an inductor, and more particularly, to an inductor that contains magnetic field propagation to reduce electromagnetic coupling between surrounding electrical components.

### BACKGROUND OF THE DISCLOSURE

Generally, embedded inductors have certain design limitations based upon the application of the embedded inductor and the environment with which the embedded inductor is operating. One example of a design limitation is when the embedded inductor is embedded in a prefabricated circuit board (PCB), and an alternating electrical current is applied to the inductor, such that a magnetic field is emitted from the inductor, which can affect the operation of adjacent electrical components. Another exemplary design limitation on an embedded inductor is the size of the inductor, which can affect the shape of the application that includes the embedded inductor. For example, if the inductor is embedded in a PCB, then the overall size of the PCB can be affected by the size and shape of the embedded inductor.

In reference to FIG. 1, one exemplary conventional inductor is a planar inductor that is generally shown at reference identifier 10. The planar inductor 10 typically has a plurality of rings 12A-12F that are connected to one another, so that each ring has a different radius with respect to a center point 14. All of the rings 12A-12F extend around the center point 14 in the same direction. As shown in FIG. 1, the rings 12A-12F extend around the center point 14 in the clockwise direction. As an alternating electrical current is applied to the planar inductor 10, the magnetic field generated from the planar inductor 10 is typically emitted in all directions. Thus, there is generally no containment of the magnetic field during the use of the inductor 10, which can negatively (or adversely) affect adjacent electrical components.

With regards to FIG. 2, another exemplary conventional inductor is a helical inductor that is generally shown at reference identifier 20. The helical inductor 20 includes multiple circular, stacked rings 22A-22D that are connected to one another. The rings 22A-22D are typically stacked, such that they are parallel with respect to one another, and the rings 22A-22D have the same radius. Similar to the planar inductor 10 (FIG. 1), the rings 22A-22D of the helical inductor 20 extend in the same direction. As shown in FIG. 2, the rings 22A-22D extend in the clockwise direction. When an alternating electrical current is applied to the helical inductor 20, the magnetic field generated from the helical inductor 20 typically is emitted in all directions from around the rings 22A-22D. Thus, the magnetic field is generally not contained around the rings 22A-22D, which can negatively (or adversely) affect adjacent electrical components.

In regards to FIG. 3, a conventional toroidal inductor is generally shown at reference identifier 26. The toroidal inductor 26 includes a plurality of top segments 27 and bottom segments 28, wherein the top and bottom segments 27, 28 are electrically connected to each other by a plurality of connectors 29. The top and bottom segments 27, 28 are positioned to form a circular shape of the toroidal inductor 26. When an alternating electrical current is applied to the toroidal inductor 26, the magnetic field generated from the toroidal inductor 26 typically remains between the top and bottom segments 27, 28. However, the toroidal inductor 26 is generally large in size when compared to other inductors, such as the planar inductor 10 and the helical inductor 20, due to the hollow center and stacked positioning of the top and bottom segments 27,28. Thus, the size of the toroidal inductor 26 can adversely affect the overall size of the electrical device with which the toroidal inductor 26 is being used.

### SUMMARY OF THE INVENTION

According to one aspect of the present invention, an inductor includes a first set of layers of an electrically conductive material wound in a first predetermined direction, wherein each layer of the first set of layers is electrically connected to one another. The inductor further includes a second set of layers of the electrically conductive material wound in a second predetermined direction, wherein each layer of the second set of layers is electrically connected to one another and the first set of layers. The second set of layers is between a top layer of the first set of layers and a bottom layer of the first set of layers, such that the top layer forms a first pair with one of the second set of layers, and the bottom layer forms a second pair with another one of the second set of layers so that magnetic field formed from an electrical current propagating through the first and second sets of layers is substantially contained, such as to remain substantially within a gap defined between each layer of the first and second pairs of layers.

According to another aspect of the present invention, an inductor includes a first set of layers of an electrically conductive material wound in a first predetermined direction to form coils, wherein each layer of the first set of layers is electrically connected to one another. The inductor further includes a second set of layers of the electrically conductive material wound in a second predetermined direction to form coils, wherein each of the first and second sets of layers is formed in a substantially circular shape by a plurality of connected rings, such that each ring of the layer has a different radius from a center point. Each layer of the second set of layers is electrically connected to one another and the first set of layers, and the second set of layers is between a top layer of the first set of layers and a bottom layer of the first set of layers. The top layer forms a first pair with one of the second set of layers, and the bottom layer forms a second pair with another one of the second set of layers so that magnetic field generated from an electrical current propagating through the first and second sets of layers is substantially contained, such as to remain substantially within a gap defined between each layer of the first and second pairs of layers, wherein at least one of inductance of an inductor corresponds to a size of the gap and a resonant frequency of the inductor corresponds to a size of an area defined between the first and second pairs of layers.

According to yet another aspect of the present invention, a method of containing the magnetic field emitted from an inductor includes the steps of positioning a first set of layers and a second set of layers with respect to one another to form an inductor, wherein the second set of layers is between a top layer of the first set of layers and a bottom layer of the first set of layers. The method further includes the steps of propagating an electrical current through a first set of layers and a second set of layers, and containing the magnetic field, wherein the magnetic field substantially remains within said inductor, such as within a gap between the layers of a pair of layers formed by one layer from the first set of layers and a layer from the second set of layers.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is a perspective view of a prior art planar inductor;

FIG. 2 is a perspective view of a prior art helical inductor;

FIG. 3 is a perspective view of a prior art toroidal inductor;

FIG. 4 is a perspective view of an inductor, in accordance with one embodiment of the present invention;

FIG. 5 is a cross-sectional view of the inductor taken along the line 5-5 of FIG. 4, wherein the electromagnetic energy emitted and shielded by an inductor is illustrated, in accordance with one embodiment of the present invention;

FIG. 6 is a perspective view of an inductor, in accordance with an alternate embodiment of the present invention;

FIG. 7 is a cross-sectional view of the inductor taken along the line 7-7 of FIG. 5, wherein the electromagnetic energy emitted and shielded by the inductor is illustrated, in accordance with the alternate embodiment of the present invention;

FIG. 8 is a cross-sectional view of the inductor of FIG. 3, in accordance with one embodiment of the present invention;

FIG. 9 is a top plan view of inductors embedded in a circuit board, according to one embodiment of the present invention; and

FIG. 10 is a flow chart illustrating a method of containing the magnetic field emitted from an inductor, in accordance with one embodiment of the present invention.

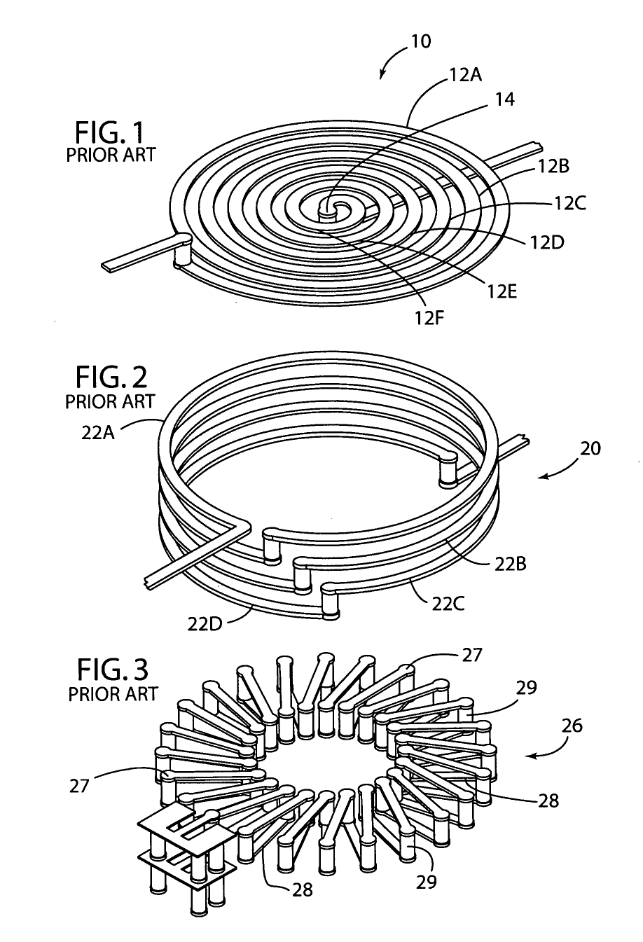

### DESCRIPTION OF PREFERRED EMBODIMENTS

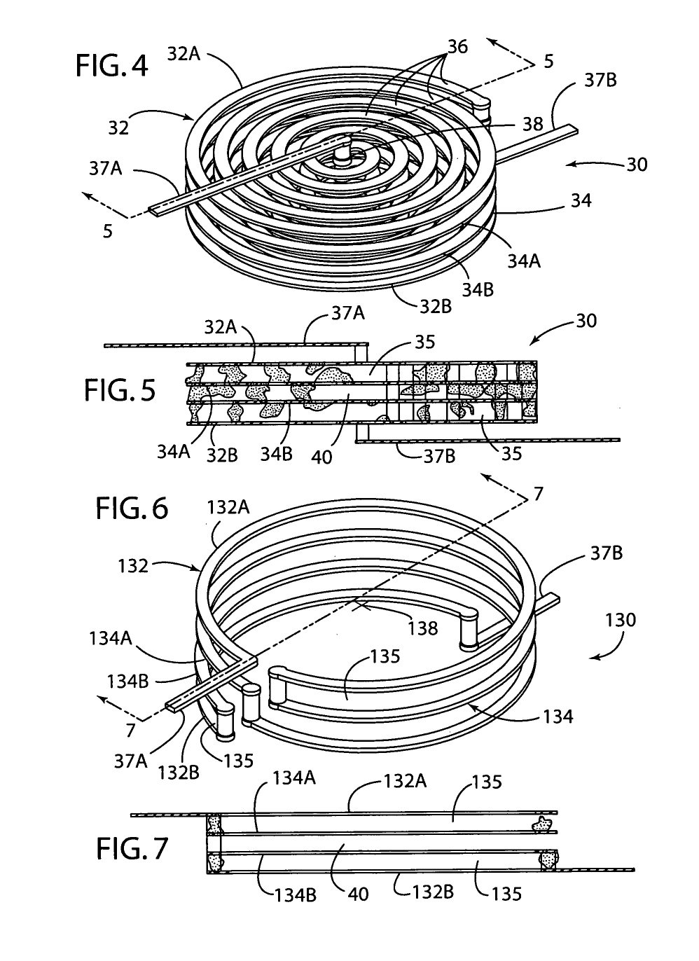

In reference to FIG. 4, an inductor is generally shown at reference identifier 30, according to one embodiment. The inductor 30 is configured in a multiple layer pattern, and includes a first set of layers generally indicated at 32 and a second set of layers generally indicated at 34. The first set of layers 32 are made of an electrically conductive material that is wound in a first predetermined direction, wherein each layer of the first set of layers 32 is electrically connected to one another. The second set of layers 34 is made of an electrically conductive material that is wound in a second predetermined direction, wherein each layer of the second set of layers 34 is electrically connected to one another and the first set of layers 32.

According to one embodiment, the second set of layers 34 are between a top layer 32A of the first set of layers 32 and a bottom layer 32B of the first set of layers 32. The top layer 32A forms a first pair with a first layer 34A of the second set of layers 34, and the bottom layer 32B forms a second pair with another one, or a second layer 34B, of the second set of layers 34. The magnetic field formed from an electrical current propagating through the first and second layers 32,34 is substantially shielded or contained to remain generally within a gap 35 (FIGS. 4-8) defined between each layer of the first and second pairs of layers, as described in greater detail herein. Thus, the inductor 30 limits or contains magnetic field propagation, such that magnetic flux lines are limited, which reduces the electromagnetic coupling between surrounding electrical components.

For purposes of explanation and not limitation, the magnetic field is electromagnetic interference (EMI) that is emitted, and which can interfere with surrounding electrical components, according to one embodiment. Typically, the electrical current propagated through the inductor 30 is an alternating current (AC), according to one embodiment. However, it should be appreciated by those skilled in the art that other types of electrical currents can be propagated through the inductor 30.

By way of explanation and not limitation, the first predetermined direction is a counter-clockwise and the second predetermined direction is a clockwise direction. According to one embodiment, the first set of layers 32 is wound in a counter-clockwise direction, and the second set of layers 34 is wound in a clockwise direction. Thus, each pair of layers formed from one layer of the first set of layers 32 and another layer of the second set of layers 34 is formed by one layer wound in each direction (i.e., counter-clockwise and clockwise). It should be appreciated by those skilled in the art that the direction of the first and second sets of layers 32,34 can be either direction, so long as the direction of the first and second sets of layers 32,34 are different. Thus, the pair of layers formed between one of the first and second sets of layers 32,34 includes a layer wound in both directions.

According to one embodiment, the electrically conductive material can be, but is not limited to, a thick-film silver conductor used in a low temperature co-fired ceramic (LTCC) sintering process. For purposes of explanation and not limitation, the inductor 30 can include six (6) tape layers of LTCC, wherein the thickness and quantity of layers can be modified to alter the inductor 30 values, as described in greater detail below.

Additionally, the inductor 30 includes a first segment 37A electrically connected to the top layer 32A, and a second segment 37B electrically connected to the bottom layer 32B, according to one embodiment. For purposes of explanation and not limitation, an electrical current is supplied to the inductor 30 by the first segment 37A, such that the electrical current then propagates through the first and second layers 32,34 and exits or is drawn from the inductor 30 through the second segment 37B. Thus, the first and second segments 37A,37B are electrically connected to the inductor 30, so that the electrical current can propagate through the entire inductor 30. However, it should be appreciated by those skilled in the art that the first and second segments 37A,37B can be electrically connected to other predetermined portions of the inductor 30, so that an electrical current can be supplied to the inductor 30 and drawn from the inductor 30.

With respect to the embodiment shown in both FIGS. 4 and 5, the first and second sets of layers 32,34 are coils. Thus, the coil of each of the first and second sets of layers 32,34 is formed in a substantially circular shape by a plurality of electrically connected rings 36. Each ring 36 of each layer 32,34 has a different radius from a center point 38. According to one embodiment, each of the first and second sets of layers 32,34 has a substantially equal number of rings 36. It should be appreciated by those skilled in the art that the first and second sets of layers 32,34 can have any predetermined number of rings, which can be, but is not limited, based upon the electrical current propagated through the inductor 30.

In further regards to FIG. 5, the magnetic field produced by the inductor 30 when an electrical current is propagated through the inductor 30, is substantially shielded or maintained between the layers of the first and second pairs of layers 32,34. The area where a significant amount of magnetic field is present is represented by the shaded areas of FIG. 5. Typically, the magnetic field is shielded and maintained in the gap 35 between the top layer 32A and the first layer 34A and the second pair formed by the second layer 34B and bottom layer 32B. Thus, the magnetic field produced by the inductor 30 is substantially shielded and maintained, such that the magnetic field substantially remains or is substantially contained within the parameters of the inductor 30.

According to an alternate embodiment, an inductor is generally shown in both FIGS. 6 and 7 at reference identifier 130, wherein like reference characters indicate like elements. The inductor 130 can include first and second sets of layers generally indicated at 132,134, each being at least a portion of a single loop of the electrically conductive material. Thus, the first and second sets of layers 132,134 include the electrically conductive material that is wound in the first and second predetermined directions, respectively. As set forth above, the first set of layers 132 can be wound in the clockwise direction, and the second set of layers 134 can be wound in the counter-clockwise direction, as shown in the embodiment of FIG. 6. Additionally, each loop of the first and second sets of layers 132,134 has a substantially equal radius from a center point 138.

As described above, pairs of layers formed from a top layer 132A of the first set of layers 132 and a first layer 134A of the second set of layers 134 form a pair and shield and maintain the magnetic field, such that the magnetic field remains substantially within a gap 135 defined between each layer 132A, 134A of the pairs of layers. Likewise, a second layer 134B of the second set of layers 134 and a bottom layer 132B of the first set of layers 132B form a pair of layers, wherein the magnetic field produced by the inductor 130 when the electrical current propagates through the inductor 130 is substantially shielded and maintained within the gap 135 defined by the pairs of layers.

In further regards to FIG. 7, the areas of significant magnetic field produced by the inductor 130 when an electrical current is propagated through the inductor 130 is represented by the shading. Thus, the magnetic field is substantially shielded and maintained within the gaps 135 formed by the pairs of layers.

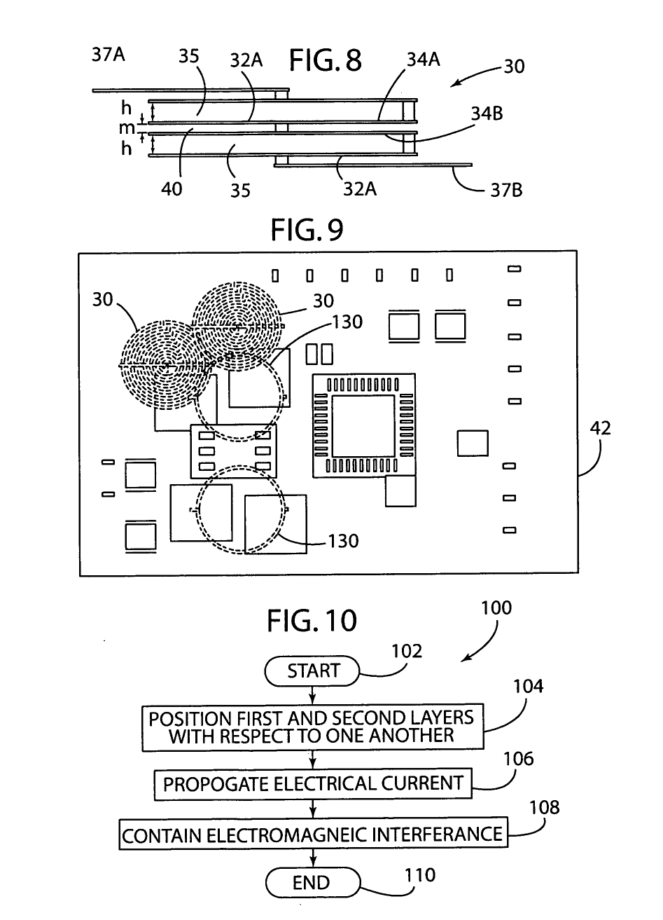

In reference to FIG. 8, an inductance of the inductor 30 corresponds to a size h of the gap 35 between the layers 32,34 forming the pairs of layers, according to one embodiment. By way of explanation and not limitation, the size h of the gap 35 can be, but is not limited to, four millimeters (4 mm) or eight millimeters (8 mm), according to one embodiment. It should be appreciated by those skilled in the art that the size h of the gap 35 does not have to be equal for the gaps 35 between each set of pairs of layers. It should further be appreciated by those skilled in the art that the size h of the gap 35 also affects the inductance of the inductor 130, and is shown in FIG. 8 with respect to the embodiment of the inductor 30 for purposes of explanation.

Additionally or alternatively, a resonant frequency of the inductor 30 corresponds to a size m of an area 40 defined between the pairs of layers. By way of explanation and not limitation, the size m of the area 40 can be, but is not limited to, four millimeters (4 mm) or eight millimeters (8 mm), according to one embodiment. It should be appreciated by those skilled in the art that the size m of the area 40 does not have to be equal for all of the areas 40 between each of the pairs of layers, when more than two pairs of layers are present. It should further be appreciated by those skilled in the art that the size m of the area 40 also affects the inductance of the inductor 130, and is shown in FIG. 8 with respect to the embodiment of the inductor 30 for purposes of explanation.

According to one embodiment, the inductor 30,130 is at least partially embedded in a circuit board 42, as shown in FIG. 9. Thus, the inductor 30,130 can be completely embedded in the circuit board 42. Alternatively, the inductor 30,130 can be a surface mount electrical component on the circuit board 42, or partially embedded in the circuit board 42.

With respect to FIG. 10, a method of shielding magnetic field emitted from the inductor 30,130 is generally shown at reference identifier 100. The method 100 starts at step 102, and proceeds to step 104, wherein the first and second sets of layers 32,34,132,134 are positioned with respect to one another. At step 106, electrical current is propagated through the first and second sets of layers 32,34,132,134. Thus, the magnetic field is formed and emitted from the inductor 30,130 based upon the electrical current propagating through the first and second sets of layers 32,34,132,134. At step 108, the magnetic field is contained and shielded between the pairs of layers that are formed by the first and second sets of layers 32,34,132,134. The method then ends at step 110. According to one embodiment, the magnetic field is shielded based upon the position of the first and second sets of layers 32,34 with respect to one another, such that the first set of layers 32,132 are wound in a first predetermined direction, and the second set of layers 34,134 are wound in a second predetermined direction.

By way of explanation and not limitation, in operation, the inductor 30,130 can be employed in systems or devices, wherein circuit networks are matched for impedance matching and signal integrity. One exemplary use of the inductor 30,130 and method 100 is a filtering device in a satellite digital audio radio (SDAR) system that filters signals at approximately 2.4 gigahertz (GHz). Thus, the inductor 30,130 and method 100 generally limit the magnetic field in the Z-axis, thereby allowing flexibility as to the location of the inductor 30,130 in the circuit board 42 (FIG. 9), according to one embodiment.

Advantageously, the inductor 30,130 and method 100 can be used to shield and maintain magnetic field that results from propagating an electrical current through the inductor 30,130, according to one embodiment. Generally, the inductor 30,130 has a minimal thickness and diameter, and thus, can occupy a minimal amount of area on a circuit board 42, according to one embodiment. Therefore, the inductor 30,130 shields and maintains the magnetic field, so that the magnetic field does not affect adjacent electrical components, while having an adequate size for use in electronic circuit boards, which contain other electrical components. It should be appreciated by those skilled in the art that the inductor 30,130 and method 100 can also have additional or alternative advantages.

The above description is considered that of preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

1. An inductor comprising:
a first set of layers of an electrically conductive material wound in a first predetermined direction, wherein each layer of said first set of layers is electrically connected to one another; and
a second set of layers of said electrically conductive material wound in a second predetermined direction, wherein each layer of said second set of layers is electrically connected to one another and said first set of layers, and said second set of layers is between a top layer of said first set of layers and a bottom layer of said first set of layers, such that said top layer forms a first pair with one of said second set of layers and said bottom layer forms a second pair with another one of said second set of layers so that a magnetic field formed from an electrical current propagating through said first and second sets of layers is substantially contained, such as to remain substantially within a gap defined between each layer of said first and second pairs of layers.

2. The inductor of claim 1, wherein said first predetermined direction is counter-clockwise and said second predetermined direction is clockwise.

3. The inductor of claim 1, wherein said electrically conductive material of said first and second sets of layers are wound to form coils, and each of said first and second sets of layers are formed in a substantially circular shape by a plurality of connected rings, such that each said ring of each said layer has a different radius from a center point.

4. The inductor of claim 3, wherein each of said first and second sets of layers have a substantially equal number of rings.

5. The inductor of claim 1, wherein each layer of said first and second sets of layers is at least a portion of a single loop of said electrically conductive material in said first and second predetermined directions, respectively, such that each said loop of each said first and second sets of layers has a substantially equally radius from a center point.

6. The inductor of claim 1, wherein an inductance of an inductor corresponds to a size of said gap.

7. The inductor of claim 1, wherein a resonant frequency of an inductor corresponds to a size of an area defined between said pairs of layers.

8. The inductor of claim 1, wherein an inductor is used in a satellite digital audio radio (SDAR) system.

9. The inductor of claim 1, wherein an inductor is at least partially embedded in a low temperature co-fired ceramic (LTCC) material.

10. An inductor comprising:
a first set of layers of an electrically conductive material wound in a first predetermined direction to form coils, wherein each layer of said first set of layers is electrically connected to one another; and
a second set of layers of said electrically conductive material wound in a second predetermined direction to form coils, wherein each of said first and second sets of layers is formed in a substantially circular shape by a plurality of connected rings, such that each said ring of said layer has a different radius from a center point, each layer of said second set of layers is electrically connected to one another and said first set of layers, and said second set of layers is between a top layer of said first set of layers and a bottom layer of said first set of layers, such that said top layer forms a first pair with one of said second set of layers, and said bottom layer forms a second pair with another one of said second set of layers so that a magnetic field formed from an electrical current propagating through said first and second sets of layers is substantially shielded, such as to remain substantially within a gap defined between each layer of said first and second pairs of layers, wherein at least one of inductance of an inductor corresponds to a size of said gap and a resonant frequency of said inductor corresponds to a size of an area defined between said first and second pairs of layers.

11. The inductor of claim 10, wherein said first predetermined direction is counter-clockwise and said second predetermined direction is clockwise.

12. The inductor of claim 10, wherein each of said first and second sets of layers has a substantially equal number of rings.

13. The inductor of claim 10, wherein an inductor is used in a satellite digital audio radio (SDAR) system.

14. The inductor of claim 10, wherein an inductor is at least partially embedded in a low temperature co-fired ceramic (LTCC).

15. A method of shielding a magnetic field emitted from an inductor, said method comprising the steps of:
positioning a first set of layers and a second set of layers with respect to one another to form an inductor, wherein said second set of layers is between a top layer of said first set of layers and a bottom layer of said first set of layers;
propagating an electrical current through a first set of layers and a second set of layers; and
containing a magnetic field, wherein said magnetic field substantially remains within said inductor, such as within a gap between said layers of a pair of layers formed by one layer from said first set of layers and a layer from said second set of layers.

16. The method of claim 15 further comprising the step of controlling an inductance of said inductor by altering a size of said gap.

17. The method of claim 15 further comprising the step of controlling a resonant frequency of said inductor by altering a size of an area between said pairs of layers.

18. The method of claim 15, wherein said first predetermined direction is counter-clockwise and said second predetermined direction is clockwise.

19. The method of claim 15, wherein said first and second sets of layers are wound to form coils, and each of said first and second sets of layers is formed in a substantially circular shape by a plurality of connected rings, such that each said ring of each said layer has a different radius from a center point.

20. The method of claim 15, wherein each layer of said first and second sets of layers is at least a portion of a single loop of said electrically conductive material in said first and second predetermined directions, respectively, such that each said loop of each said layer of said first and second sets of layers has a substantially equally radius from a center point.
